(19) United States
(12) Patent Application Publication
(10) Pub. No.: US 2026/0322061 A1
(43) Pub. Date: Oct. 15, 2026

(54) VACUUM-GAP OPTICAL CAVITY AND ASSOCIATED METHODS

(71) Applicants: THE REGENTS OF THE UNIVERSITY OF COLORADO, A BODY CORPORATE, Denver, CO (US); YALE UNIVERSITY, NEW HAVEN, CT (US); GOVERNMENT OF THE UNITED STATES OF AMERICA, AS REPRESENTED BY THE SECRETARY OF COMMERCE, GAITHERSBURG, MD (US)

(72) Inventors: SCOTT A. DIDDAMS, LOUISVILLE (CO); FRANKLYN J QUINLAN, LONGMONT, CO (US); YIFAN LIU, BOULDER, CO (US); MEGAN L. KELLEHER, BOULDER, CO (US); CHARLES A. MCLEMORE, BOULDER, CO (US); PETER THOMAS RAKICH, NEW HAVEN, CT (US); NAIJUN JIN, NEW HAVEN, CT (US)

(21) Appl. No.: 19/482,693

(22) PCT Filed: May 7, 2024
(86) PCT No.: PCT/US2024/028195

§ 371 Date: Nov. 7, 2025

Related U.S. Application Data
(60) Provisional application No. 63/464,913, filed on May 8, 2023.

(51) Int. Cl. H01S 3/08; G02B 5/08; G02B 5/10

(52) U.S. Cl. CPC H01S 3/08059; G02B 5/0808; G02B 5/10

(57) ABSTRACT

A vacuum-gap optical cavity includes a spacer having a first spacer surface and a second spacer surface, a first mirror having a first reflective coating formed on a first substrate, and a second mirror having a second reflective coating formed on a second substrate. The spacer forms a cavity region that extends between a first aperture at the first spacer surface and a second aperture at the second spacer surface. The first mirror is bonded to the first spacer surface such that the first reflective coating overlaps the first aperture and such that the first mirror completely covers the first aperture. The second mirror is bonded to the second spacer surface such that the second reflective coating overlaps the second aperture and such that the second mirror completely covers the second aperture. The cavity region is maintained under vacuum without active pumping.

### RELATED APPLICATIONS

This application claims priority to U.S. Provisional Patent Application No. 63/464,913, filed May 8, 2023, which is incorporated herein by reference in its entirety.

### STATEMENT REGARDING FEDERALLY SPONSORED RESEARCH OR DEVELOPMENT

This invention was made with government support under grant number OAC1940231, awarded by NIST. The government has certain rights in the invention.

### BACKGROUND

Lasers that are frequency-locked to an optical cavity exhibit greatly reduced phase and frequency fluctuations. Such “ultrastable” lasers have applications in, for example, metrology and sensing, time-keeping and optical atomic clocks, and photonic microwave generation. When locked, the laser's frequency and phase stability is ultimately determined by the length stability of the optical cavity. Typically, the optical cavity includes two mirrors composed of high reflectivity coatings deposited on a glass or crystalline substrate. To improve the length stability, the optical cavity also includes a rigid spacer to which the mirrors are bonded, typically via optical contact bonding. The spacer forms a center cavity that extends between the mirrors so that light in the cavity (i.e., resonant light exciting a mode of the cavity) does not overlap, or otherwise interact with, the spacer.

### SUMMARY

One aspect of the present embodiments includes the realization that to reap the stability benefits of a Fabry-Perot reference cavity, the reference cavity must operate within a vacuum enclosure. Air within the spacer's center cavity induces undesirable optical-path-length fluctuations that decreases the stability of the reference cavity. Therefore, for many reference cavities, the center cavity is evacuated via a side vent hole that leads from the outer edge of the spacer to the center cavity. During operation, the cavity assembly is placed within a vacuum enclosure where the vacuum inside the center cavity is typically maintained with an ion pump (which itself may be backed by a turbo pump and a rotary-vane pump).

The present embodiments simplify the operation and use of Fabry-Perot reference cavities by eliminating the need for active pumping of the center cavity. By bonding the mirrors and spacer inside of a vacuum chamber-and not including the side vent hole-vacuum is maintained within the center cavity both after the cavity is removed from the vacuum chamber and without any active pump connected to the center cavity. Advantageously, the vacuum-gap optical cavity of the present embodiments operates in a normal air environment without suffering from air-induced optical path length fluctuations within the center cavity.

Compared to the prior-art approach of actively pumping on the center cavity during laser-lock operation, the use of in-vacuum bonding to form the vacuum-gap optical cavity offers several advantages. First, the vacuum-gap optical cavity is usable in compact and mobile systems where power draw and space requirements do not allow for a vacuum pump. Second, the vacuum-gap optical cavity does not suffer from loss of vacuum due to power outages or during transport where power is not be available. Third, the vacuum-gap optical cavity obviates the need for bulky and expensive vacuum enclosures and pumps.

In embodiments, a vacuum-gap optical cavity includes a spacer having a first spacer surface and a second spacer surface. The spacer forms a cavity region that extends between a first aperture at the first spacer surface and a second aperture at the second spacer surface. The vacuum-gap optical cavity also includes a first mirror having a first reflective coating formed on a first substrate. The first mirror is bonded to the first spacer surface such that the first reflective coating at least partially overlaps the first aperture and such that the first mirror completely covers the first aperture. The vacuum-gap optical cavity also includes a second mirror having a second reflective coating formed on a second substrate. The second mirror is bonded to the second spacer surface such that the second reflective coating at least partially overlaps the second aperture and such that the second mirror completely covers the second aperture. The cavity region is maintained under vacuum without active pumping.

### BRIEF DESCRIPTION OF THE FIGURES

FIG. 1A illustrates a vacuum-gap optical cavity, in embodiments.

FIG. 1B illustrates side views of components of the vacuum-gap optical cavity of FIG. 1A prior to assembly, in embodiments.

FIG. 1C illustrates top views of components of the vacuum-gap optical cavity of FIG. 1A prior to assembly, in embodiments.

FIG. 2A is a side view of a vacuum bonder for optical contact bonding components together to form vacuum-gap optical cavity of FIG. 1A, in embodiments.

FIG. 2B is a side view of a manufacturing jig for use with the vacuum bonder of FIG. 2A, in embodiments.

FIG. 3 is a schematic diagram of a Pound-Drever-Hall locking setup for testing the vacuum-gap optical cavity of FIG. 1A.

FIG. 4 is a graph of measured phase noise versus laser frequency.

FIG. 5 is a graph of Allan deviation versus time.

FIG. 6 is a flowchart of a method for manufacturing the vacuum-gap optical cavity of FIG. 1A, in embodiments.

FIG. 7 illustrates a vacuum-gap optical cavity array, in embodiments.

### DETAILED DESCRIPTION

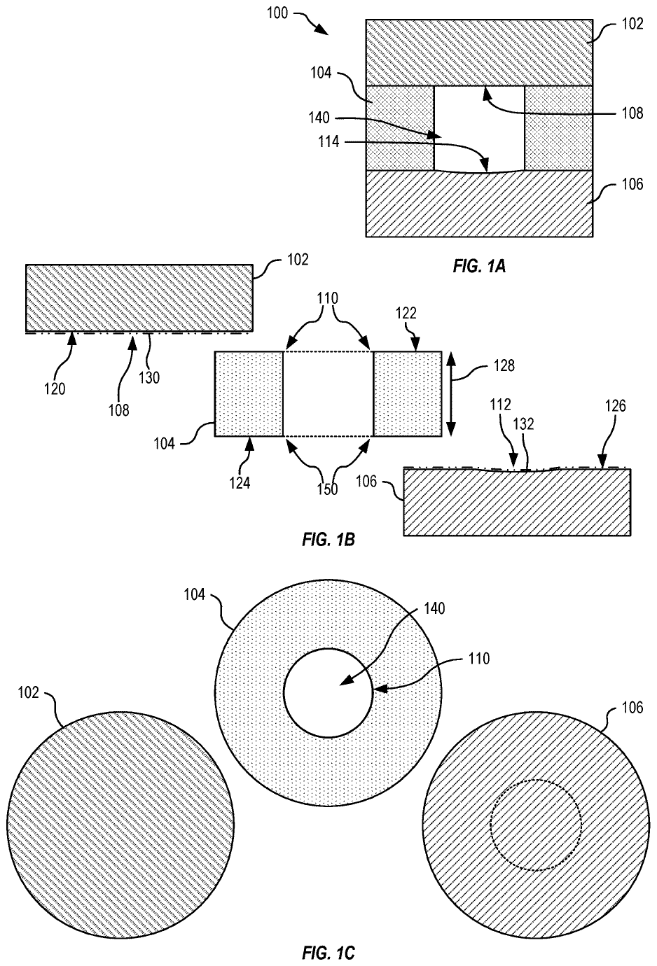

FIG. 1A illustrates a vacuum-gap optical cavity 100, in accordance with the present embodiments. FIG. 1B illustrates side views of components of vacuum-gap optical cavity 100 of FIG. 1A prior to assembly. FIG. 1C illustrates top views of components of vacuum-gap optical cavity 100 of FIG. 1A prior to assembly. FIGS. 1A-1C are best viewed together with the following description.

Vacuum-gap optical cavity 100 is cylindrical in shape and includes three components that are stacked on top of each other: a flat mirror substrate 102, a cylindrical spacer 104 forming a cavity region 140 (e.g., a bore hole), and a curved mirror substrate 106. Cavity region 140 extends through spacer 104 between a first aperture 110 that coincides with a first surface 122 of spacer 104 and a second aperture 150 that coincides with a second surface 124 of spacer 104 that is opposite first surface 104. While FIGS. 1A-1C show vacuum-gap optical cavity 100 as being cylindrical, vacuum-gap optical cavity 100 may alternatively have another shape (e.g., a rectangular prism or rectangular cuboid).

In one embodiment, vacuum-gap optical cavity 100 has a diameter of 25.4 mm and an overall length of 19.05 mm. In certain embodiments, flat mirror substrate 102, cylindrical spacer 104, and curved mirror substrate 106 are each formed of ultra-low expansion (ULE) glass. Other materials that these components may be fabricated from include, but are not limited, sapphire, fused silica, silicon, and Zerodur®. Flat mirror substrate 102 and curved mirror substrate 106 are each 6.35 mm long cylindrical mirror substrates. In certain embodiments, cylindrical spacer 104 is 6.35 mm long; however, cylindrical spacer 104 may alternatively have another length (e.g., to achieve a specified cavity resonance linewidth or to fit within an overall specified volume or footprint).

Flat mirror substrate 102 has a super-polished surface 120 that is at least partially coated by a highly reflective dielectric coating 130 to form a flat mirrored surface 108. Examples of dielectric coating 130 include, but are not limited to, a Bragg mirror stack formed from alternating thin films of SiO₂ and Ta₂O₅. In certain embodiments, highly reflective dielectric coating 130 covers all of super-polished surface 120. In other embodiments, highly reflective dielectric coating 130 covers only a region of super-polished surface 120 that aligns with, and at least partially covers, first aperture 110. Curved mirror substrate 106 has super-polished surface 126, a portion of which is curved and coated with a highly reflective dielectric coating 132 to form a curved mirror 112. In certain embodiments, highly reflective dielectric coating 132 covers all of super-polished surface 126. In other embodiments, highly reflective dielectric coating 132 covers only the region of curved mirror 112. In certain embodiments, curved mirror 112 is concave with a radius of curvature of 1 m; however, curved mirror 112 may have a different value for the radius of curvature without departing from the scope hereof. Surfaces 120, 122, 124, and 126 may be super-polished, having a typical surface roughness of about 1 Å, for example, which is smooth enough for optical contact bonding.

Flat mirror substrate 102, cylindrical spacer 104, and curved mirror substrate 106 are optical-contact bonded together inside a vacuum enclosure such that cavity region 140, after contact bonding, is hermetically sealed and under vacuum (e.g., having a pressure of 500 Pa or less) without any active pumping. A thickness 128 of cylindrical spacer 104 effectively defines a length of cavity region 140 and therefore a corresponding set of resonance frequencies of vacuum-gap optical cavity 100. Accordingly, thickness 128 may be selected for the desired resonance frequency. Further, the diameter of center aperture 110 and overall size and shape of flat mirror substrate 102, cylindrical spacer 104, and curved mirror substrate 106 may also be selected based on intended use. For example, vacuum-gap optical cavity 100 may be sized to have a long spacer length and smaller cross-sectional diameter.

Curved mirror substrate 106 may have a radius of curvature equal to the length of spacer 104. In this case, vacuum-gap optical cavity forms a half-confocal geometry. In other embodiments, curved mirror substrate 106 is replaced by a flat mirror substrate such that cavity region 140 is formed with two flat mirrors (i.e., a plane-parallel Fabry-Perot cavity). In yet other embodiments, flat mirror substrate 102 is replaced by a second curved mirror substrate such that cavity region 140 is formed with two curved mirrors (e.g., a confocal geometry).

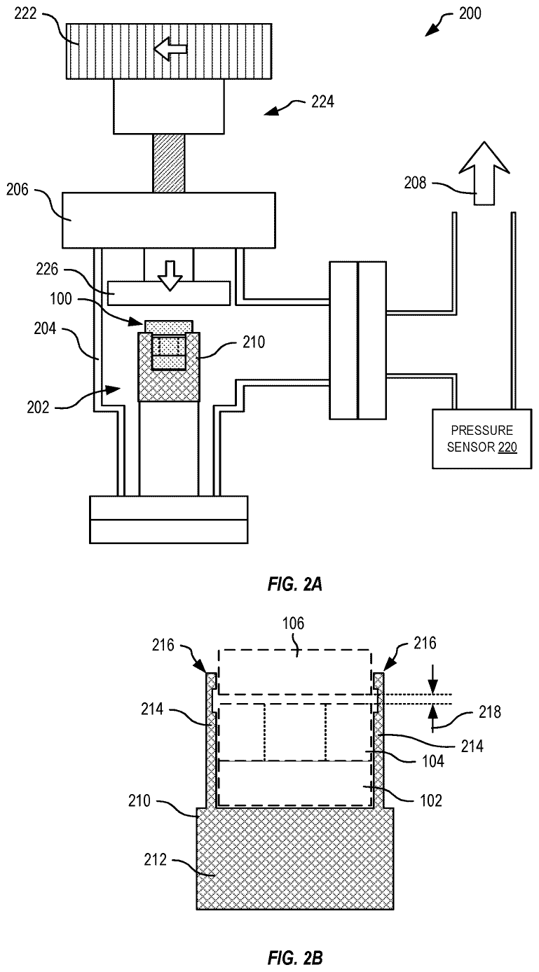

Flat mirror substrate 102 and curved mirror substrate 106 may be bonded to cylindrical spacer 104 using optical contact bonding (e.g., as described below with regards to FIGS. 2A and 2B). Alternatively, flat mirror substrate 102 and curved mirror substrate 106 may be bonded to cylindrical spacer 104 using anodic bonding. In this case, cylindrical spacer 104 may be made of silicon while flat mirror substrate 102 and curved mirror substrate 106 are each fabricated from borosilicate glass (e.g., Corning 7740 or Schott 8330), or vice versa. Alternatively, flat mirror substrate 102 and curved mirror substrate 106 may be bonded to cylindrical spacer 104 using hydroxide-catalysis bonding. Other vacuum-compatible bonding techniques may be used without departing from the scope hereof.

While FIG. 1A shows vacuum-gap optical cavity 100 as having only two mirrors, vacuum-gap optical cavity 100 may alternatively be constructed with three or more mirrors to create standing-wave cavities of various geometries. In other embodiments, vacuum-gap optical cavity 100 has three or more mirrors configured to create traveling-wave cavities of various geometries (e.g., four-mirror rectangular ring cavities, four-mirror bowtie cavities, six-mirror cavities, etc.).

FIG. 2A is a side view of a vacuum bonder 200 for optical contact bonding flat mirror substrate 102, cylindrical spacer 104, and curved mirror substrate 106 together to form vacuum-gap optical cavity 100 of FIG. 1A, in accordance with the present embodiments. FIG. 2B is a side view of a manufacturing jig 210 for use with vacuum bonder 200 of FIG. 2A, in accordance with the present embodiments. FIGS. 2A and 2B are best viewed together with the following description. Note that the orientation of components in FIGS. 2A and 2B is inverted as compared to FIG. 1A; either orientation may be used.

Vacuum bonder 200 includes a vacuum chamber 202 formed within a housing 204 and that is accessible via a high-vacuum (HV) valve 206 (e.g., HV bellows valve). Vacuum bonder 200 also includes manufacturing jig 210 that aligns flat mirror substrate 102, cylindrical spacer 104, and curved mirror substrate 106 of vacuum-gap optical cavity 100 in preparation for optical contact bonding. Vacuum chamber 202 connected to a vacuum pump (not shown, e.g., a turbo pump backed by a roughing pump) that extracts air from vacuum chamber 202, as indicated by arrow 208.

As shown in FIG. 2B, jig 210 includes a base portion 212 and a plurality (e.g., four) of prongs 214 positioned and oriented to receive components of vacuum-gap optical cavity 100. A base portion of each prong is sized to receive cylindrical spacer 104 and curved mirror substrate 106 without significant friction but prongs 214 are sized and positioned with tolerances that maintain alignment of the components with one another. A tip 216 of each prong 214 is sized and positioned to grip (e.g., collectively clamp and grip using friction) flat mirror substrate 102 such that flat mirror substrate 102 is secure but movable when a force is applied.

In preparation for optical contact bonding, flat mirror substrate 102 is placed at a bottom of jig 210 and cylindrical spacer 104 is placed directly on flat mirror substrate 102. Curved mirror substrate 106 is positioned within tips 216 of prongs 214 such that it is held a distance 218 (e.g., ~2 mm) above cylindrical spacer 104. That is, a gap is left between flat super-polished surface 124 and super-polished surface 126. Jig 210 and the assembled components are then placed in vacuum chamber 202 via HV valve 206, and vacuum chamber 202 is sealed. Air is then pumped out of vacuum chamber 202 and the pressure within vacuum chamber 202 is monitored by a pressure sensor 220.

Once the pressure inside vacuum chamber 202 is at or below a desired pressure (e.g., 10⁻³ Pa), a handwheel 222 of a rotary/linear displacement mechanism 224 (e.g., part of valve 206) is turned to lower a force platform 226 within vacuum chamber 202 such that curved mirror substrate 106 is forced into contact with cylindrical spacer 104. Force platform 226 applies a constant force to curved mirror substrate 106 such that super-polished surface 126 of curved mirror substrate 106 bonds to flat super-polished surface 124 of cylindrical spacer 104, and flat super-polished surfaces 122 of cylindrical spacer 104 bonds to has super-polished surface 120 of flat mirror substrate 102. The vacuum pump is then stopped and air is allowed to enter vacuum chamber 202. Vacuum-gap optical cavity 100 is removed from vacuum chamber 202 and allowed to settle for two days. Atmospheric pressure holds the components (e.g., flat mirror substrate 102, cylindrical spacer 104, and curved mirror substrate 106) of vacuum-gap optical cavity 100 together to maintain the vacuum within cavity region 140, since the bonding is substantially airtight due to the high quality of surfaces 120, 122, 124, and 126. Advantageously, cavity region 140 is itself a miniature vacuum chamber and thereby achieves good stability of its intra-cavity optical path length, enhancing frequency stability without a bulky vacuum enclosure or components (e.g., pumps, gauges, bellows, etc.)

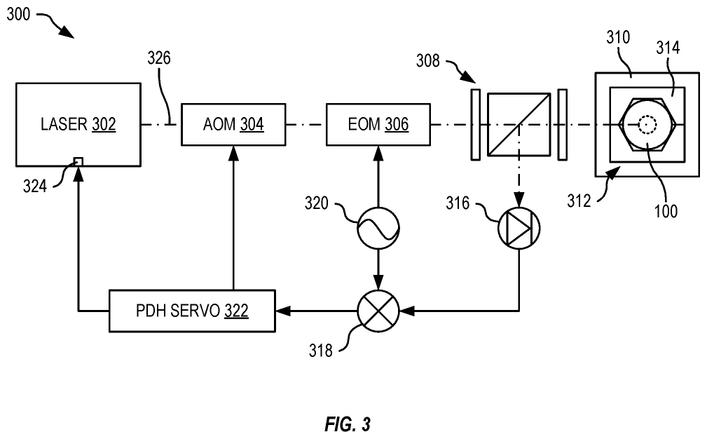

FIG. 3 is a schematic diagram of a Pound-Drever-Hall (PDH) locking setup 300 for testing vacuum-gap optical cavity 100 of FIGS. 1A-1C. PDH locking setup 300 includes a laser 302, an acousto-optic modulator (AOM) 304, an electro-optic modulator (EOM) 306, a free-space circulator 308, an air-tight box 310, a V-groove holder 314, a photodetector 316, a double-balanced mixer (DBM) 318, a 10-MHz signal generator 320, and a PDH servo 322. Laser 302 is, for example, a 1550-nm commercial fiber laser.

Vacuum-gap optical cavity 100 is mounted into v-groove holder 314, which is positioned in air-tight box 310 (e.g., a stainless-steel box) to provide temperature and air pressure control of air 312 within air-tight box 310, as well as acoustic isolation. Air-tight box 310 is not evacuated and temperature of air 312 is actively maintained near room temperature. Laser 302 is stabilized to vacuum-gap optical cavity 100 via the PDH method implemented by PDH locking setup 300. Laser 302 is PDH locked to a 1550-nm TEM00 mode of vacuum-gap optical cavity 100 with fast feedback control achieved through AOM 304 and slow feedback control through the laser's piezoelectric tuning port 324 driven by PDH servo 322. PDH locking setup 300 is placed in a passive acoustic isolation box with active vibration cancellation in order to probe the fundamental limits of vacuum-gap optical cavity 100.

To measure the phase noise of the cavity-stabilized light 326, the stabilized light 326 is split into two channels and compared with two different optical references: (a) an optical frequency comb (OFC) stabilized to a local oscillator of a Yb clock, and (b) a 1550-nm cavity-stabilized laser that is offset by 8.9 GHz from the resonance frequency of vacuum-gap optical cavity 100. The two heterodyne beat notes with the two references are digitally sampled and cross-correlated to reveal noise of stabilized laser 302. Vacuum-gap optical cavity 100 is measured to have a finesse of 850,000 at 1550 nm, corresponding to a linewidth of 27.8 kHz.

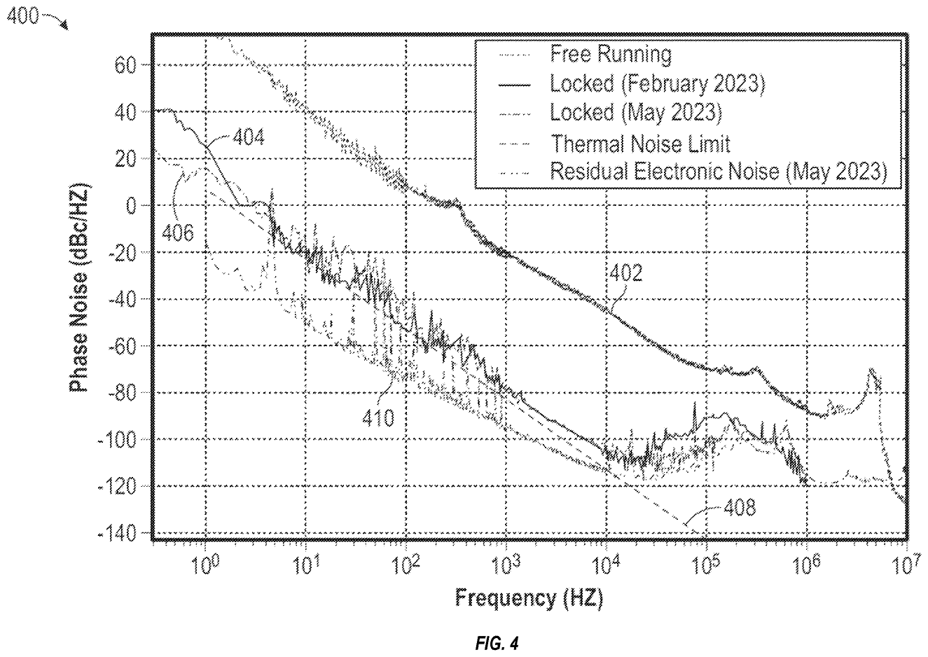

FIG. 4 is a graph 400 of measured phase noise versus the frequency of laser 302, illustrating a free-running phase noise 402, a first locked phase noise 404, a second locked phase noise 406, a thermal noise limit 408, and a residual electronic noise 410. Phase noise measurements of laser 302 PDH locked to vacuum-gap optical cavity 100 were performed at two weeks and again at four months after vacuum-gap optical cavity 100 was bonded. As shown in graph 400, the measured phase noise of laser 302 follows the estimated thermal noise limit 408 from 10 Hz to 1 kHz offset and reaches around −105 dBc/Hz at 10 kHz offset. This phase noise may be used to estimate the residual gas level in cavity region 140, which may be determined to have an upper limit pressure of 500 Pa. Thus, near-thermal noise-limited phase noise performance may be achieved under only modest vacuum levels. To measure the fractional frequency stability, the heterodyne beat is tracked between cavity-stabilized light 326 and the stabilized OFC to acquire a fractional frequency change over time for laser 302 and calculate Allan deviation (ADEV).

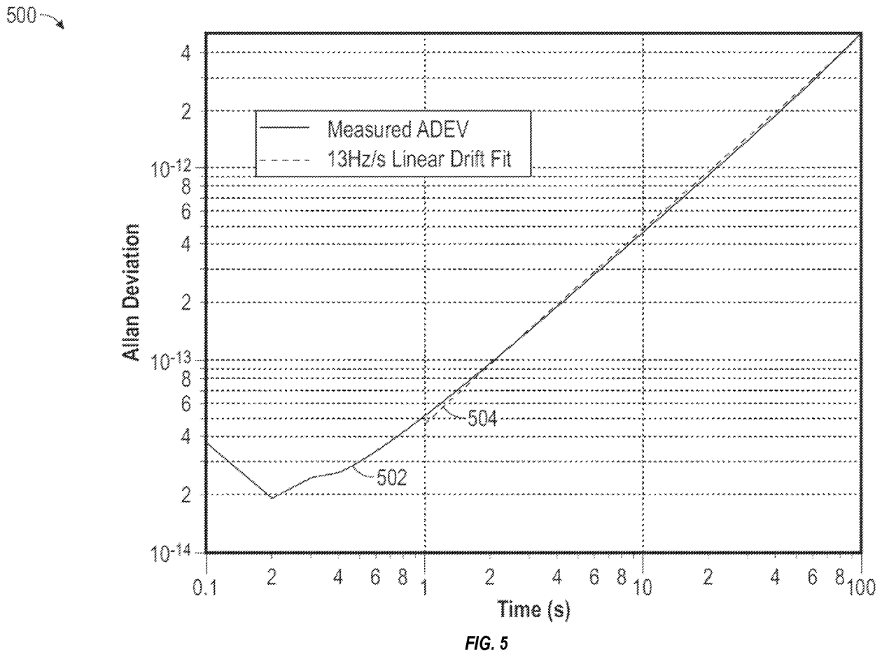

FIG. 5 is a graph 500 of Allan deviation versus time for a measured ADEV 502 and a 13 Hz/s linear drift fit 504. As shown in FIG. 5, ADEV 502 reaches 5×10⁻¹⁴ at 1 s and is dominated by a ~13 Hz/s linear drift at longer timescales. Advantageously, this near-thermal-noise-limited optical phase noise performance and fractional frequency instability are achieved with only an air-tight box surrounding the vacuum-gap optical cavity and without any active pumping. The cavity bonding method is compatible with other cavity geometries, such as long spacer length and smaller cross-sectional diameter. These results point to a new path toward compact and portable ultrastable laser systems for out-of-lab applications.

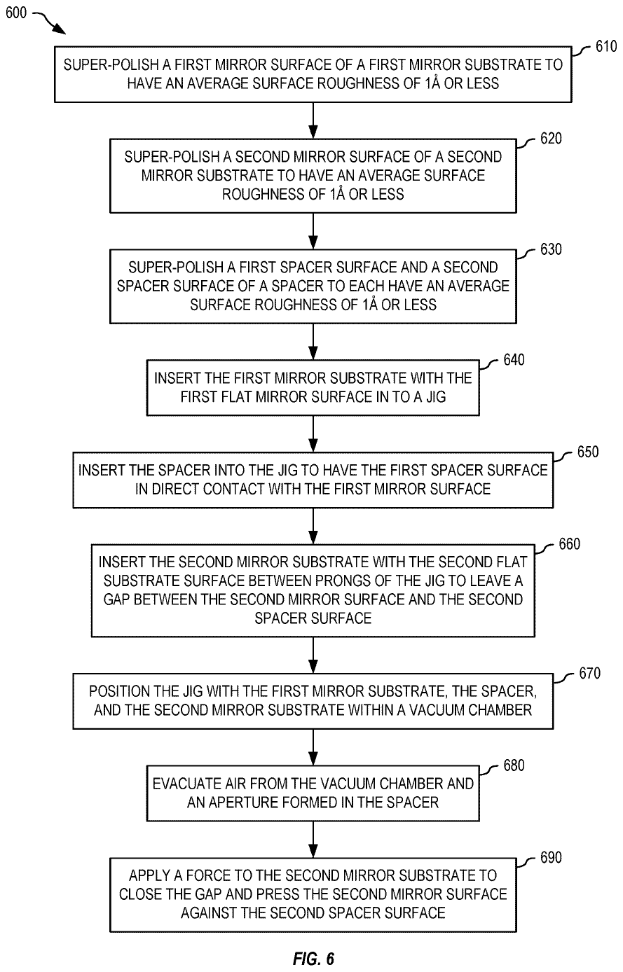

FIG. 6 is a flowchart of a method 600 for manufacturing vacuum-gap optical cavity 100 of FIGS. 1A-1C, in accordance with the present embodiments. Method 600 may be performed using vacuum bonder 200 of FIG. 2. At block 610, method 600 super-polishes a first mirror surface of a first mirror substrate to have an average surface roughness of 1 Å or less. In one example of block 610, surface 120 of flat mirror substrate 102 is super-polished to have an average surface roughness of 1 Å. At block 620, method 600 super-polishes a second mirror surface of a second mirror substrate to have an average surface roughness of 1 Å or less. In one example of block 620, surface 126 of curved mirror substrate 106 is super-polished to have an average surface roughness of 1 Å. At block 630, method 600 super-polishes a first spacer surface and a second spacer surface of a spacer to each have an average surface roughness of 1 Å or less. In one example of block 630, surfaces 122 and 124 of cylindrical spacer 104 are super-polished to have an average surface roughness of 1 Å.

At block 640, method 600 inserts the first mirror substrate with the first substrate mirror surface into a jig. In one example of block 640, flat mirror substrate 102 is inserted into jig 210 of FIG. 2. At block 650, method 600 inserts the spacer into the jig to have the first spacer surface in direct contact with the first mirror surface. In one example of block 650, cylindrical spacer 104 is inserted into jig 210 such that flat super-polished surface 122 directly contacts super-polished surface 120. At block 660, method 600 inserts the second mirror substrate with the second flat substrate surface between prongs of the jig to leave a gap between the second mirror surface and the second spacer surface. In one example of block 660, curved mirror substrate 106 is inserted between tips 216 of prongs 214 that hold curved mirror substrate 106 using friction to leave distance 218 between flat super-polished surfaces 124 and 126.

At block 670, method 600 positions the jig with the first mirror substrate, the spacer, and the second mirror substrate within a vacuum chamber. In one example of block 670, jig 210 with flat mirror substrate 102, cylindrical spacer 104, and curved mirror substrate 106 is positioned within vacuum chamber 202 via valve 206. At block 680, method 600 evacuates air from the vacuum chamber and an aperture formed in the spacer. In one example of block 680, a vacuum pump is activated to remove air from vacuum chamber 202 to form a vacuum having an air pressure, indicated by pressure sensor 220, of approximately 10-3 Pa, whereby air is also removed from within center aperture 110 via the gap between super-polished surface 120 and flat super-polished surface 122. At block 690, method 600 applies a force to the second mirror substrate to close the gap and press the second flat substrate surface against the second flat spacer surface. In one example of block 690, handwheel 222 of a rotary/linear displacement mechanism 224 is turned to lower force platform 226 within vacuum chamber 202 to force flat mirror substrate 106 is forced into contact with cylindrical spacer 104 such that has super-polished surface 120 presses against flat super-polished surfaces 122 while the vacuum is maintained. Air is then allowed to enter vacuum chamber 202 to release the vacuum and vacuum-gap optical cavity 100 is removed from jig 210.

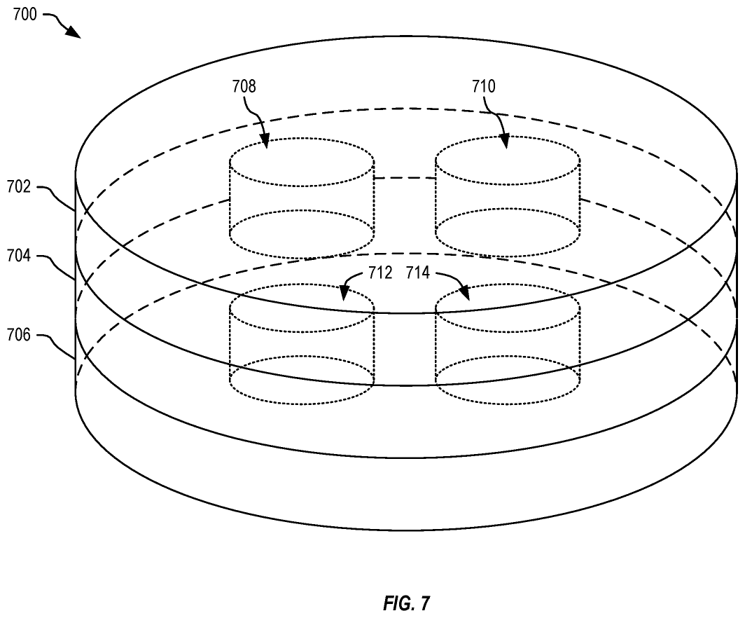

FIG. 7 illustrates a vacuum-gap optical cavity array 700, in accordance with the present embodiments. In the example of FIG. 7, flat mirror substrate 702 is similar to flat mirror substrate 102 of FIGS. 1A-1C, cylindrical spacer 704 is similar to cylindrical spacer 104, and curved mirror substrate 706 is similar to curved mirror substrate 106, except that cylindrical spacer 704 forms four apertures 708, 710, 712, and 714 where reflective surfaces of flat mirror substrate 702 and curved mirror substrate 706 align with each of apertures 708, 710, 712, and 714, and where curves of curved mirror substrate 706, if included, also align with each of apertures 708, 710, 712, and 714. Vacuum-gap optical cavity array 700 is fabricated similarly to vacuum-gap optical cavity 100 of FIG. 1A to form four optical resonators. Although shown with four optical resonators, vacuum-gap optical cavity array 700 may have any number of optical resonators without departing from the scope hereof.

While the vacuum-gap optical cavities are described herein as being constructed with conventional planar and curved mirrors, the present embodiments include vacuum-gap optical cavities made with mirrors that are fabricated using unconventional techniques. For example, curved mirror substrate 106 of FIGS. 1A-1C may be fabricated using lithographic patterning and etching, as described in N. Jin et al., “Micro-fabricated mirrors with finesse exceeding one million,” Optica 9, pp. 965-970 (September 2022).

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### Combinations of Features

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:

(A1) A vacuum-gap optical cavity includes a spacer having a first spacer surface and a second spacer surface. The spacer forms a cavity region that extends between a first aperture at the first spacer surface and a second aperture at the second spacer surface. The vacuum-gap optical cavity also includes a first mirror having a first reflective coating formed on a first substrate. The first mirror is bonded to the first spacer surface such that the first reflective coating at least partially overlaps the first aperture and such that the first mirror completely covers the first aperture. The vacuum-gap optical cavity also includes a second mirror having a second reflective coating formed on a second substrate. The second mirror is bonded to the second spacer surface such that the second reflective coating at least partially overlaps the second aperture and such that the second mirror completely covers the second aperture. The cavity region is maintained under vacuum without active pumping.
(A2) In the vacuum-gap optical cavity denoted (A1), the first mirror is bonded to the first spacer surface via optical-contact bonding, anodic bonding, or hydroxide-catalysis bonding. The second mirror is bonded to the second spacer surface via optical-contact bonding, anodic bonding, or hydroxide-catalysis bonding.
(A3) In either of the vacuum-gap optical cavities denoted (A1) and (A2), the first reflective surface includes a first dielectric coating deposited on the first mirror substrate. The second reflective surface includes a second dielectric coating deposited on the second mirror substrate.
(A4) In any of the vacuum-gap optical cavities denoted (A1) to (A3), the first reflective surface and the second reflective surface face each other to form a Fabry-Perot cavity that overlaps the cavity region.
(A5) In any of the vacuum-gap optical cavities denoted (A1) to (A4), one or both of the first mirror and the second mirror is curved.
(A6) In the vacuum-gap optical cavity denoted (A5), said one or both of the first mirror and the second mirror is concave.
(A7) In any of the vacuum-gap optical cavities denoted (A1) to (A6), one or both of the first mirror and the second mirror is planar.
(A8) In any of the vacuum-gap optical cavities denoted (A1) to (A7), the first reflective coating is formed on a super-polished surface of the first substrate and the second reflective coating is formed on a super-polished surface of the second substrate.
(A9) In any of the vacuum-gap optical cavities denoted (A1) to (A8), at least one of the spacer, the first mirror substrate, and the second mirror substrate is made from ultra-low expansion glass.
(A10) In any of the vacuum-gap optical cavities denoted (A1) to (A9), a vacuum pressure in the cavity region is 500 Pa or less.
(B1) A method for fabricating any one of the vacuum-gap optical cavities denoted (A1) to (A10) includes inserting the first mirror into a jig; inserting the spacer into the jig such that first spacer surface directly contacts the first mirror; inserting the second mirror between prongs of the jig such that a gap is formed between the second mirror and the second spacer surface; positioning the jig, with the first mirror, spacer, and second mirror inserted thereon, inside a vacuum chamber; pumping the vacuum chamber to evacuate the vacuum chamber and the cavity region; applying a force to the second mirror to close the gap; and bonding the first mirror to the first spacer surface and the second mirror to the second spacer surface.
(B2) In the method denoted (B1), the method further includes super-polishing a surface of the first substrate, depositing the first reflective coating on the super-polished surface of the first substrate, super-polishing a surface of the second substrate, and depositing the second reflective coating on the super-polished surface of the second substrate.
(B3) In either of the methods denoted (B1) and (B2), the method further includes lithographically patterning and etching a surface of the first substrate, depositing the first reflective coating on the lithographically patterned and etched surface of the first substrate, lithographically patterning and etching a surface of the second substrate, and depositing the second reflective coating on the lithographically patterned and etched surface of the second substrate.
(B4) In any of the methods denoted (B1) to (B3), said bonding the first mirror to the first spacer surface occurs prior to said positioning.
(B5) In any of the methods denoted (B1) to (B3), said bonding the first mirror to the first spacer surface occurs within the evacuated vacuum chamber.
(B6) In any of the methods denoted (B1) to (B5), said bonding comprises optical contact bonding, anodic bonding, or hydroxide-catalysis bonding.
(B7) In any of the methods denoted (B1) to (B6), said applying the force includes actuating a linear actuator to translate the second mirror through the prongs of the jig such that the second mirror directly contacts the spacer.
(B8) In any of the methods denoted (B1) to (B7), said pumping includes pumping to a pressure of 500 Pa or less.
(B9) In any of the methods denoted (B1) to (B8), the method further includes removing the vacuum-gap optical cavity from the vacuum chamber.

What is claimed is:

1. A vacuum-gap optical cavity, comprising:
a spacer having a first spacer surface and a second spacer surface, the spacer forming a cavity region that extends between a first aperture at the first spacer surface and a second aperture at the second spacer surface;
a first mirror comprising a first reflective coating formed on a first substrate, the first mirror being bonded to the first spacer surface such that the first reflective coating at least partially overlaps the first aperture and such that the first mirror completely covers the first aperture; and
a second mirror comprising a second reflective coating formed on a second substrate, the second mirror being bonded to the second spacer surface such that the second reflective coating at least partially overlaps the second aperture and such that the second mirror completely covers the second aperture;
wherein the cavity region is maintained under vacuum without active pumping.

2. The vacuum-gap optical cavity of claim 1, wherein:
the first mirror is bonded to the first spacer surface via optical-contact bonding, anodic bonding, or hydroxide-catalysis bonding; and
the second mirror is bonded to the second spacer surface via optical-contact bonding, anodic bonding, or hydroxide-catalysis bonding.

3. The vacuum-gap optical cavity of claim 1, wherein:
the first reflective surface comprises a first dielectric coating deposited on the first mirror substrate; and
the second reflective surface comprises a second dielectric coating deposited on the second mirror substrate.

4. The vacuum-gap optical cavity of claim 1, wherein the first reflective surface and the second reflective surface face each other to form a Fabry-Perot cavity that overlaps the cavity region.

5. The vacuum-gap optical cavity of claim 1, one or both of the first mirror and the second mirror being curved.

6. The vacuum-gap optical cavity of claim 5, said one or both of the first mirror and the second mirror being concave.

7. The vacuum-gap optical cavity of claim 1, one or both of the first mirror and the second mirror being planar.

8. The vacuum-gap optical cavity of claim 1, wherein:
the first reflective coating is formed on a super-polished surface of the first substrate; and
the second reflective coating is formed on a super-polished surface of the second substrate.

9. The vacuum-gap optical cavity of claim 1, at least one of the spacer, the first mirror substrate, and the second mirror substrate comprising ultra-low expansion glass.

10. The vacuum-gap optical cavity of claim 1, a vacuum pressure in the cavity region being 500 Pa or less.

11. A method for fabricating the vacuum-gap optical cavity of claim 1, comprising:
inserting the first mirror into a jig;
inserting the spacer into the jig such that first spacer surface directly contacts the first mirror;
inserting the second mirror between prongs of the jig such that a gap is formed between the second mirror and the second spacer surface;
positioning the jig, with the first mirror, spacer, and second mirror inserted thereon, inside a vacuum chamber;
pumping the vacuum chamber to evacuate the vacuum chamber and the cavity region;
applying a force to the second mirror to close the gap; and
bonding the first mirror to the first spacer surface and the second mirror to the second spacer surface.

12. The method of claim 11, further comprising:
super-polishing a surface of the first substrate;
depositing the first reflective coating on the super-polished surface of the first substrate;
super-polishing a surface of the second substrate; and
depositing the second reflective coating on the super-polished surface of the second substrate.

13. The method of claim 11, further comprising:
lithographically patterning and etching a surface of the first substrate;
depositing the first reflective coating on the lithographically patterned and etched surface of the first substrate;
lithographically patterning and etching a surface of the second substrate;
depositing the second reflective coating on the lithographically patterned and etched surface of the second substrate.

14. The method of claim 11, wherein said bonding the first mirror to the first spacer surface occurs prior to said positioning.

15. The method of claim 11, wherein said bonding the first mirror to the first spacer surface occurs within the evacuated vacuum chamber.

16. The method of claim 11, wherein said bonding comprises optical contact bonding, anodic bonding, or hydroxide-catalysis bonding.

17. The method of claim 11, wherein said applying the force comprises actuating a linear actuator to translate the second mirror through the prongs of the jig such that the second mirror directly contacts the spacer.

18. The method of claim 11, wherein said pumping comprises pumping to a pressure of 500 Pa or less.

19. The method of claim 11, further comprising removing the vacuum-gap optical cavity from the vacuum chamber.
